(19) United States
(12) Patent Application Publication
(10) Pub. No.: US 2023/0216850 A1
(43) Pub. Date: Jul. 6, 2023

(54) Remotely Accessing an Endpoint Device Using a Distributed Systems Architecture

(71) Applicant: TruU, Inc., Palo Alto, CA (US)

(72) Inventors: David Brett Pasirstein, Denver, CO (US); Lucas Allen Budman, Denver, CO (US)

(21) Appl. No.: 18/091,883

(22) Filed: Dec. 30, 2022

Related U.S. Application Data
(60) Provisional application No. 63/295,330, filed on Dec. 30, 2021.

(51) Int. Cl. H04L 9/40

(52) U.S. Cl. CPC H04L 63/0884; H04L 63/102; H04L 63/107

(57) ABSTRACT

A distributed identity server cluster maintains a first communication channel between an endpoint device in a first geographic region and a first server. The first server receives a request from the endpoint device to communicate with an application containing a digital key for accessing the endpoint device and stored at an authentication device located in a second geographic region. The server cluster transmits a notification to the application with instructions for the authentication device to connect to the server cluster. The server cluster opens a second communication channel between the authentication device and a second server in communication with the first server. The server cluster transmits data between the endpoint device and the authentication device across the first communication channel and the second communication channel.

### CROSS REFERENCE TO RELATED APPLICATIONS

This application claims the benefit of U.S. Provisional Patent Application No. 63/295,330, filed on Dec. 30, 2021, which is incorporated by reference herein in its entirety for all purposes.

### TECHNICAL FIELD

This disclosure relates generally to techniques for virtualizing a computer system and, more specifically, to techniques for virtualizing a computing system using a distributed systems architecture.

### BACKGROUND

Some conventional security systems involve a smart card reader built into or plugged into a universal serial bus (USB) port of a computer, which scans a “chip” integrated into a target user's plastic smart card. To access the computer, a target user authenticates their access credentials by inserting their smart card using the smart card reader for the computer. When the smart card is inserted into or scanned by the smart card reader, the computer communicates with the smart card, for example using application data protocol unit (ADPU) commands. The computer tracks the presence of the smart card in the smart card reader such that the computer recognizes when the smart card is ejected and takes action in response, for example by locking the user out of the computer. The computer may also challenge (i.e., communicate with) the smart card at any point while inserted in the smart card reader. For example, if the computer requests a new token every three hours after a target user has signed in, the computer may access the inserted smart card to cryptographically sign the request. Other conventional systems implement USB Fast Identity Online 2 (FIDO2) and FIDO U2F fobs, which operate similar to the conventional smart card systems described above. Because communication between the smart card and the smart card reader can be bi-directional, the computer must believe that the smart card is physically connected with the computer. Accordingly, conventional systems are incompatible with implementations where a target user's smart card is loaded onto their mobile device because the mobile device and the computer are not directly connected.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows a user identification system 100 for authenticating a target user requesting access to an endpoint device, according to one embodiment.

FIG. 2 is an interaction diagram for communicating data between an endpoint device and an authentication device to validate an authentication request, according to one embodiment.

FIG. 3 is a block diagram of an example system architecture of an emulation module, according to one embodiment.

FIG. 4 illustrates an example process for verifying an authentication request from the perspective of the emulation module of the endpoint device, according to one embodiment.

FIG. 5 illustrates an example process for verifying an authentication request from the perspective of the emulation application 125 of the authentication device 115, according to one embodiment.

FIG. 6 shows a distributed systems architecture 600 for authenticating a target user requesting access to a secure endpoint device, according to one embodiment.

FIG. 7 is an interaction diagram for communicating data between an endpoint device and an authentication device via the distributed identity server cluster 140, according to one embodiment.

FIG. 8 illustrates an example process for transmitting data using a distributed identity server cluster from the perspective of a distributed identity server cluster 140, according to one embodiment.

FIG. 9 illustrates an example process for transmitting data using a distributed identity server cluster from the perspective of an endpoint device 110, according to one embodiment.

FIG. 10 illustrates an example process for transmitting data using a distributed identity server cluster from the perspective of an authentication device 115, according to one embodiment.

FIG. 11 is a block diagram illustrating components of an example machine able to read instructions from a machine-readable medium and execute them in a processor (or controller), according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Embodiments of a user identification system authenticate a target user's request for access to an endpoint device, for example a computer system, a networked data system resource, or a combination thereof. Embodiments of the present disclosure provide various devices, methods, and techniques for establishing bi-directional communication between an end-point computer and a mobile application stored on a mobile device of a target user.

In embodiments where the endpoint device is a computer system, the user identification system authenticates a target user's request to access the computer system by interrogating a software device driver executing on the computer system. In such embodiments, the software device driver presents itself to an operating system of computer as a software driver for a physically attached security circuit (e.g., a smart card, a universal serial bus (USB) security device). Accordingly, rather than communicating with the physically attached security circuit, the software device driver communicates with an authentication device separate from the endpoint device (e.g., a mobile device). The authentication device stores and generates authentication credentials and/or other data necessary to authenticate the target user's request for access.

The computer system communicates with the authentication device via a distributed intermediary platform. In some embodiments, the distributed intermediary platform implements multiple geographically distributed and load-balanced physical servers in communication with each other. Accordingly, the computer system may use the distributed intermediary platform to authenticate a target user in possession of an authentication device configured with authentication credentials, certificates, and/or other data for authenticating the user.

### System Environment Example

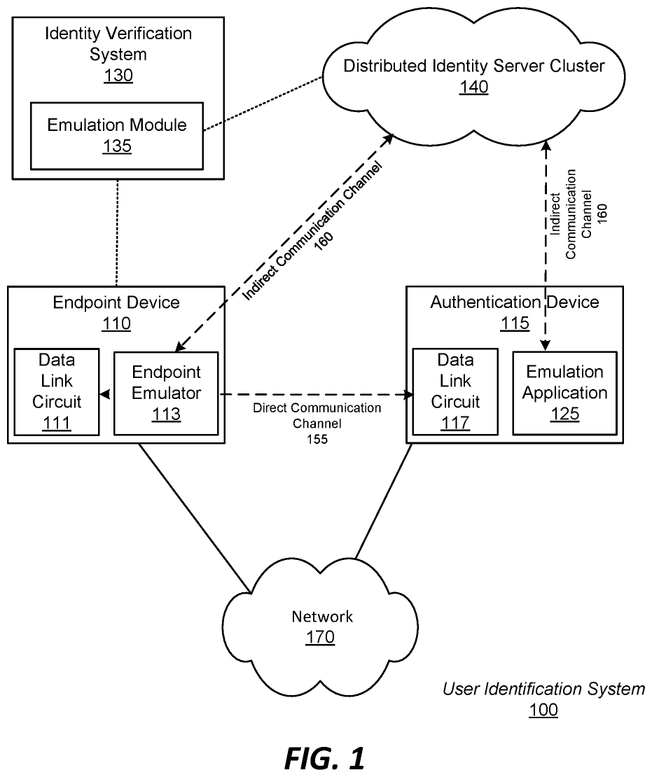

FIG. 1 shows a user identification system 11 for authenticating a target user requesting access to a secure endpoint device, according to one embodiment. The user identification system 100 may include an authentication device 115, an endpoint device 110, an identity verification system 130, a distributed identity server cluster 140, and a network 170. Although, FIG. 1 illustrates only a single instance of the components of the user identification system 100, more than one of each component may be present in practice and additional or fewer components may be used.

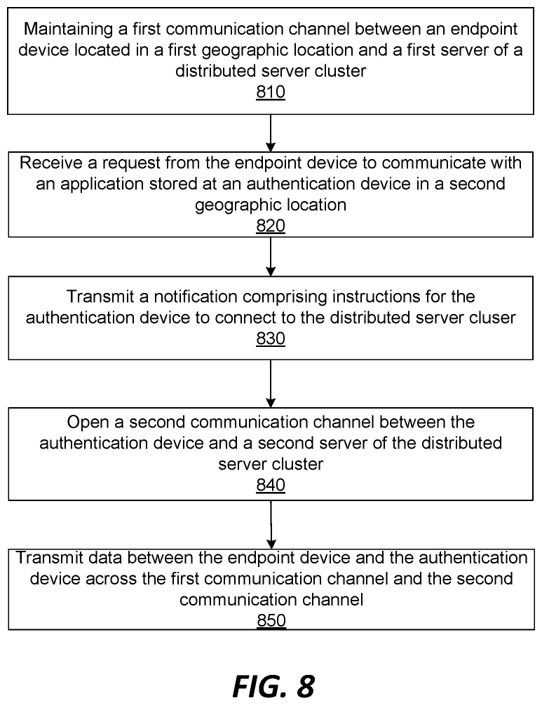

An endpoint device 110 is any computer, computer system, or networked data system resource, or combination thereof to which a target user is attempting to gain access. To gain access to the endpoint device 110, the target user authenticates their identity using an application on a mobile device (further described below with reference to the authentication device 115). The endpoint device 110 may include one or more data link circuits 111 capable of transmitting digital data. Although only one data link circuit 111 is illustrated in FIG. 1, a person having ordinary skill in the art would appreciate that in practice the endpoint device 110 may have multiple data link circuits of varying types. As discussed herein, the data link circuit 111 may be wired, wireless, optical, acoustic, or a combination thereof. Wireless data link circuits 111 implement any wireless communication technique that is both feasible and/or compliant with industry standards including, but not limited to, Bluetooth, WiFi, long term evolution (LTE), etc. Wired data link circuits 111 may implement any wired communication technique that is both feasible and/or complaint with industry standards including, but not limited to, Ethernet suite of standards. The system architecture of an endpoint device 110 that is a computer system is further illustrated in FIG. 8.

The endpoint emulator 113 convinces the endpoint device 110 that a physical key necessary to access end endpoint device 110 is locally connected to the device and is available for user. Accordingly, a target user may use the emulation application 125 to access ethe endpoint device 110 without physically plugging the authentication device 115 into the endpoint device 110. In embodiments where a target user attempts to access the endpoint device 110 using a digital key stored on a mobile application (e.g., the mobile emulator 125), an endpoint emulator 113 installed on the endpoint device 110 enables the endpoint device 110 to function as though a physical key (e.g., smartcard, fob, or other suitable key) were connected to the device and ready for use. In one embodiment, the endpoint emulator 113 is software implemented in two components: a driver and a service application (now shown). The service application communicates locally with the operating system of the endpoint device 110, the driver, and a remote system, for example the distributed identity server cluster 140. Accordingly, the driver can convince the endpoint device 110 that there is a physical key inserted into the endpoint device 110 by collaborating with the service application to send signals spoofing the insertion/loading or ejection/unloading of a physical key.

The driver and service application of the endpoint emulator 113 may cooperatively govern logic, caching, and other optimizations of the endpoint emulator 113 including, but not limited to, reducing communications or packaging communications into a structure suitable for conditions with a non-local device (e.g., wrapping the local structure into one suitable for the network). The endpoint emulator 113 may handle errors, delays, later communication attempts, and specifics of the target device such as which specific device or which specific features of the device, and/or prefix and postfix communication instructions such as indicating the start of a new transaction, a retry, or end of transaction to the remote system, service, or platform that may or may not be passed on to the target device. The endpoint emulator 113 may additionally include a credential provider application (not shown) to facilitate user interaction at the endpoint device 110, for example login, unlock, and other authentication interactions. The credential provider application instructs the endpoint emulator 113 when to behave as though the physical key were inserted and to trigger the processes for authenticating the target user further described herein.

For simplicity, the asset being accessed by the user is the endpoint device 110 itself. However, a person having ordinary skill in the art would recognize that the asset may also include any other type of resource and the techniques described herein may be applied to any other suitable asset. For example, the asset may be an object, a document on a network server, an image on the cloud, or an environment to which a target user is attempting to gain access. To gain access to the asset, the target user authenticates their identity using one or more of the techniques described herein.

The authentication device 115 comprises data link circuits 117 and an emulation application 125. The data link circuits 117 of the authentication device 115 are functionally and structurally consistent with the description provided herein of the data link circuits 111 of the endpoint device 110. The data link circuits 117 transmit and receive digital data. Although only one data link circuit 117 is illustrated in FIG. 1, a person having ordinary skill in the art would appreciate that in practice the endpoint device 110 will have multiple data link circuits of varying types. As discussed herein, the data link circuit 111 may be wired, wireless, optical, acoustic, or a combination thereof. Wireless data link circuits 117 implement any wireless communication technique that is both feasible and/or compliant with industry standards, for example, Bluetooth, WiFi, LTE, nG (n being an integer) wireless communications. Wired data link circuits 117 may implement any wired communication technique that is both feasible and/or compliant with industry standards including, but not limited to, Ethernet suite of standards. The system architecture of an authentication device 115 is further illustrated in FIG. 8.

The authentication device 115 is a computing device that generates authentication credentials and/or other data necessary to authenticate a user's request for access. Accordingly, the authentication device 115 may interact with the endpoint device 110 via the network 170. The authentication device 115 may be a mobile device carried by a target user, for example a smartphone, a tablet computer, a smartwatch, a personal digital assistant. For simplicity, the authentication device 115 is described herein as a mobile device (e.g., a cellular phone or a smartphone). A person having ordinary skill in the art, however, would recognize that authentication device 115 may also be any other type of computing device capable of executing one or more of the processing configurations described herein.

The emulation application 125 is an application stored and executing within the authentication device 115 to provide authentication based on data stored within the authentication device 115. A target user may request access to an endpoint device 110 using the emulation application 125 installed on an authentication device 115. The emulation application 125 stores a digital representation of the physical key (e.g., smart card or USB fob) necessary to access to the endpoint device 110. As described herein, the digital representation is referred to as a “digital key.” The emulation application 125 interprets, processes, and responds to APDU instructions from the endpoint device 110, which would typically be received by the physical key inserted into the endpoint device 110. The emulation application 125 provides full functionality of the physical key and enables that functionality to be communicated and executed over a network (e.g., the network 170). In some embodiments, the emulation application 125 on the authentication device 115 communications directly with the endpoint device 110 via a communication channel from a data link circuit 117 to a data link circuit 111. In other embodiments, the emulation application 125 communications indirectly with the endpoint device 110 via a communication channel with a remote system, for example the distributed identity server cluster 140 described below. The emulation application 125 may transmit a notification to the emulation application 125 to establish a communication channel between the endpoint emulator 113 and the emulation application 125.

In some embodiments, the authentication device 115 comprises one or more sensors (not shown) that are configured to collect motion data (direct and indirect) describing the movements of a user operating the authentication device 115. As described herein, the one or more sensors may include a range of sensors or data sources, either individually or in combination, for collecting direct motion data (e.g., accelerometers, gyroscopes, GPS coordinates, keyboard and mouse data, etc.) or indirect motion data (e.g., Wi-Fi data, compass data, magnetometer data, pressure information/barometer readings), or any other data recorded by a data source on or in proximity to the authentication device 115.

For simplicity, the authentication device 115 is described herein as a mobile device. A person having ordinary skill in the art, however, would recognize that the authentication device 115 may also include any other suitable type of computing device and the techniques described herein may be applied to any other suitable computing device. Examples of authentication devices 115 and corresponding suitable computing devices may be found in U.S. Pat. No. 10,713,874, which is incorporated by reference herein in its entirety.

The identity verification system 130 may be a verification system that analyzes data and draws particular inferences from the analysis. For example, the identity verification system 130 receives characteristic data collected for a target user and performs a series of analyses to generate an inference regarding the identity of the target user. Generally, the identity verification system 130 is configured to handle a wide variety of data. Accordingly, as described herein, characteristic data collected for a target user refers to both motion data and/or non-motion data. In addition to visual characteristics, target users may be characterized with particular movements and motion habits. Motion data, as described herein, describes not only a particular movement by a target user, but also additional considerations, for example the speed at which the motion occurred, or the various habits or tendencies associated with the motion. By identifying one or a combination of particular movements based on data captured by motion sensors the system may be able to identify a user from a population of users. Although techniques and embodiments described herein, may be described with reference to both non-motion and motion data, a person having ordinary skill in the art would recognize that those techniques and embodiments may be applied to motion data, non-motion data, or a combination therefore (more generally referred to as “characteristic data”).

The identity verification system 130 includes logical routines that perform a variety of functions including checking the validity of the incoming data, parsing and formatting the data if necessary, passing the processed data to a database server on the network 170 for storage, confirming that the database server has been updated, and identifying the user. The identity verification system 130 communicates, via the network 170, the results of the identification and the actions associated with the identification to the computing device 110 for presentation to a user via a visual interface.

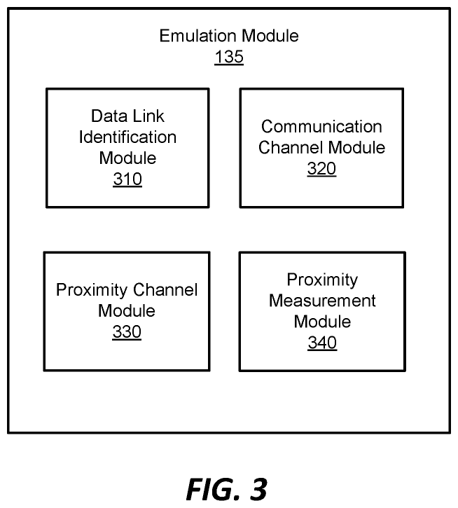

The identity verification system 130 comprises an emulation module 135, which is further described below with reference to FIG. 3. The emulation module 135 provides an application programming interface (API) to the emulation application 125 of the authentication device 115 to establish a communication channel between a data link circuit 111 and a data link circuit 117. The endpoint device 110 communicates with an authentication device 115 via a communication channel 120. As described herein, a communication channel is characterized by the data link circuits 111 and 117 that serve as endpoints for a communication path between a data link circuit 111 of the endpoint device 110 and a data link circuit 117 of the authentication device 115. The communication channel may include any technically feasible combination of data links capable of transmitting digital data. In one embodiment, the physical data links of a communication channel include, but are not limited to, wireless data links (e.g., Bluetooth, WiFi, or any other suitable electromagnetic radio frequency signal), wired data links, optical data links, acoustic data links (e.g., audible or ultrasonic), or a combination thereof In some embodiments, the communication channel may include multiple segments between data link circuits 111 and 117 with different properties, types, and data transmission rates (e.g., Bluetooth, WiFi, LTE, wired Ethernet, optical fiber, microwave data links, satellite data links etc.).

The identity verification system 130 is illustrated in FIG. 1 as being a separate system from the endpoint device 110 that is wirelessly coupled to the endpoint device 110. In the illustrated embodiment, outputs and determinations generated by the identity verification system 130 are transmitted to the endpoint device 110 with instructions for the endpoint device to grant or deny access to the target user. However, a person having ordinary skill in the art would appreciate that the components of the identity verification system 130 or the entirety of the identity verification system 130 may be integrated into the endpoint device 110, for example as software device drivers executing on an operating system of the endpoint device 110. An example of the identity verification system 130 may be found in U.S. Pat. No. 10,713,874, which is incorporated by reference herein in its entirety.

In some embodiments, the emulation module 135 and the emulation application 125 may cooperatively establish a direct communication channel 155 between the endpoint device 110 and the authentication device 115. In a first embodiment, the emulation module 135 determines the communication channel 155 and the emulation application 125 selects the appropriate data link circuit(s) 117 based on the determination. In such embodiments, the emulation module 135 determines the communication channel 155 based on the availability and state of both data link circuits 111 of the endpoint device 110 and data link circuits 117 of the authentication device 115. The emulation module 135 may characterize the state of each available data link circuit 111 and data link circuit 117. Based on the characterization, the emulation module 135 selects a combination of data link circuits 111 and 117 and determines the direct communication channel 155 between the selected combination of data link circuits. The emulation module 135 selects the necessary data link circuits 111 to establish the direct communication channel 155 from endpoint device-side. The emulation application 125 receives the determined communication channel 155 and selects the necessary data link circuits 117 to establish the communication channel 155 from the authentication device-side. In a second embodiment, the emulation module 135 and the emulation application 125 cooperatively characterize multiple potential communication channels based on factors including, but not limited to, packet loss, packet latency, physical properties of the potential communication channel (e.g., local radio frequency noise and channel utilization). Accordingly, in the second embodiment, the emulation module 135 and the emulation application 125 cooperatively determine the direct communication channel 155 before selecting the necessary data link circuits at either end of the communication channel.

In other implementations, the energy management capabilities of the authentication device 115 prevent the emulation application 125 from reliably maintaining a direct communication channel with the endpoint device 110. For example, in implementations where the authentication device is a smart phone, the authentication device 115 can only maintain the communication channel for limited number of seconds. In such embodiments, the emulation module 135 establishes an indirect communication channel 160 between the endpoint emulator 113 and the emulation application 125 via a distributed identity server cluster 140. The distributed identity server cluster 140 is a distributed intermediary platform configured to intelligently broker, publish, subscribe, and route messages across a cluster of servers. The distributed identity server cluster 140 includes one or more servers geographically distributed, load balanced, and designed for cloud scale. In the implementation where a target user accesses an endpoint device 110 from the emulation application 125, the endpoint device 110 may cache data to minimize the need for communication with the authentication device 115. The endpoint emulator 113 may receive instructions from the physically coupled reader and communicates the instructions to the emulation application via the distributed identity server cluster 140. While the endpoint emulator 113 on the endpoint device 110 may maintain a persistent communication channel with the distributed identity server cluster 140, the emulation application 125 on the authentication device 115 may a transient and/or time limited communication channel with the distributed identity server cluster.

When an endpoint device 110 initiates new or further communication with a digital key on the emulation application 125, the endpoint emulation 113 triggers a transaction at the distributed identity server cluster 140 requesting that the emulation application 125 establish an indirect communication channel 160 with the distributed identity server cluster 140. In some embodiments, the distributed identity server cluster 140 transmits a notification, for example via Apple Push Notification Service (APNS) or any suitable out of band network push notification service, notifying the emulation application 125 to re-connect with the distributed identity service cluster 140. The notification may further comprise a topic identifying the endpoint device 110 that initiated the request, also referred to as a “channel ID.” For example, the emulation application 125 may store that a given channel ID was received as part of a digital key transaction with a particular endpoint device 110. The system may use the stored channel ID to lock or logout from the endpoint device 110 via the emulation application by transmitting an instruction to lock or logout across the same indirect communication channel 160. Once the emulation application 125 re-connects to the distributed identity server cluster 140, the endpoint emulation 113 may communicate with the digital key stored on the emulation application 125. In some embodiments, the endpoint emulation 113 transmits the APDU commands for the digital key to the emulation application 125 for processing by the emulation application 125.

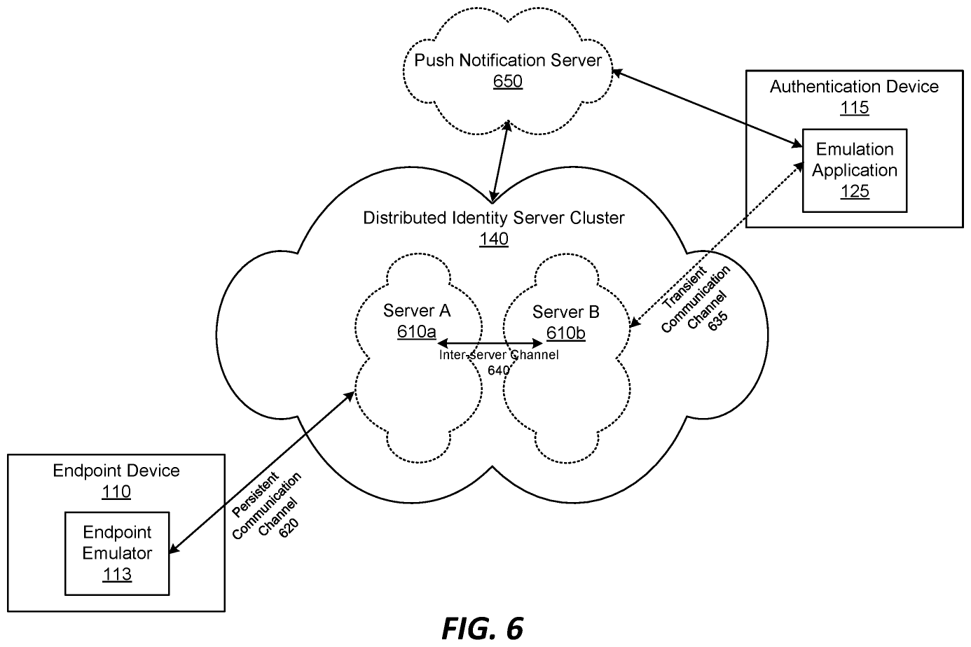

Although the distributed identity server cluster 140 is described herein with reference to accessing an endpoint device 110 using a digital key stored on a mobile application, a person having ordinary skill in the art would appreciate that the distributed identity server cluster 140 may be configured to accommodate any network capable device, for example a flash drive, a hard drive, DVD with either direct network capability or tethered to a computer, network bridge, or cellular hotspot, etc. In another embodiment, the distributed identity server cluster 140 may be configured to establish indirect communication channels between a mobile application (e.g., the emulation application 125) embedded with a digital representation of a USB security key fob and an endpoint device 110 using the techniques described herein. The distributed identity server cluster 140 is further described below with reference to FIGS. 6-10.

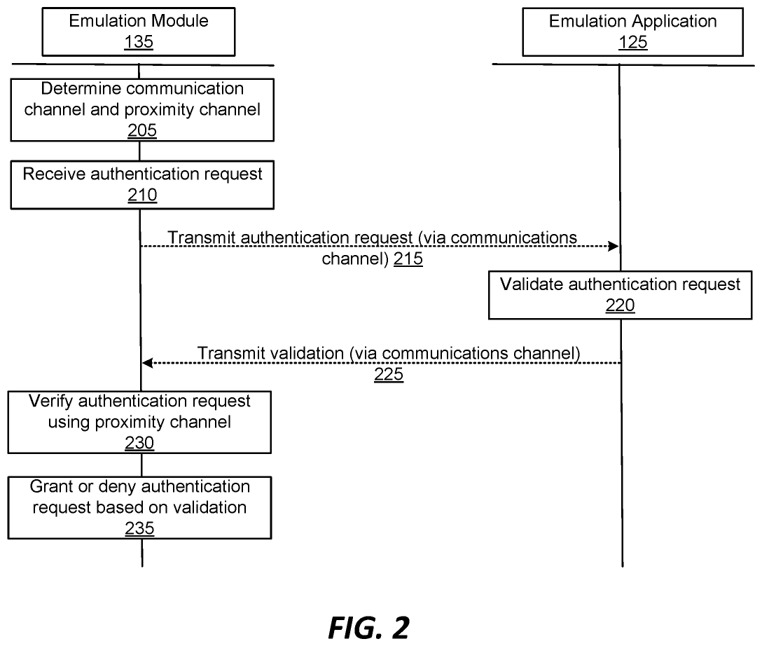

The network 170 represents the various wired and wireless communication pathways between the authentication device 115, the endpoint device 110, and the identity verification system 130, which may be wireless coupled to the endpoint device 110 or integrated into the hardware of the endpoint device 110. Network 140 uses standard Internet communications technologies and/or protocols. Thus, the network 140 can include links using technologies such as Ethernet, IEEE 802.11, integrated services digital network (ISDN), asynchronous transfer mode (ATM), etc. Similarly, the networking protocols used on the network 140 can include the transmission control protocol/Internet protocol (TCP/IP), the hypertext transport protocol (HTTP), the simple mail transfer protocol (SMTP), the file transfer protocol (FTP), etc. The data exchanged over the network 140 can be represented using technologies and/or formats including the hypertext markup language (HTML), the extensible markup language (XML), a custom binary encoding etc. In addition, all or some links can be encrypted using conventional encryption technologies such as the secure sockets layer (SSL), Secure HTTP (HTTPS) and/or virtual private networks (VPNs). In another embodiment, the entities can use custom and/or dedicated data communications technologies instead of, or in addition to, the ones described above. In alternate embodiments, components of the identity verification system 130, which are further described with reference to FIGS. 2-3 may be stored on the endpoint device 110.

### Selecting Direct Communication Channels for Multipath Authentication

FIG. 2 illustrates an interaction diagram for communicating data between an endpoint device and an authentication device 115 via a direct communication channel to validate an authentication request, according to one embodiment. The emulation module 135 determines 205 a direct communication channel and a proximity channel. In response, the emulation module 135 selects data link circuits at the computer system (e.g., the endpoint device 110) and the emulation application 123 selects data link circuits at the authentication device 115. When a target user attempts to access the computer system, the identity verification system 130 determines whether to authenticate the target user's access request and grant the target user access to the computer. Accordingly, the identity verification system 130 encodes the authentication request into a signal and transmits the encoded to signal to the emulation module 135 (e.g., via an API request), which receives 210 the request. The authentication request may include one or more underlying requests. Accordingly, the techniques described herein may be applied to any authentication process suitable for implementation by the identity verification system 130. In some embodiments, the authentication request may include one or more API calls (e.g., function calls, method calls, messages, etc.) to the emulation module 135. In other embodiments, the emulation module 135 may be stored within a user and/or kernel execution space of a primary processor circuit of the computer system or in a secondary processor circuit complex of the computer system.

The emulation module 135 transmits 215 the authentication request (i.e., the encoded signal from a data link circuit at the computer system to a corresponding data link circuit at the authentication device 115 (via the direct communication channel 120). In one embodiment, the emulation module 135 presents an API corresponding to device driver for a locally emulated smart card and the authentication request comprises at least one application protocol data unit (APDU) certificate request.

The emulation application 125 extracts the authentication request from the encoded signal and validates 220 the authentication request. The emulation application 125 encodes a reply including the validated authentication request and transmits 225 the reply from the data link circuit at the authentication device 115 to the corresponding data link circuit at the computer system. The emulation module 135 extracts the validation from the encoded reply and verifies 230 the authentication request using the proximity channel. Once verified, the emulation module 135 or any other suitable component of the identity verification system 130 may grant 235 or deny the authentication request based on whether or not the emulation application 125 validated the authentication request.

The identity verification system 130 may perform the process illustrated in FIG. 2 in response to one or more authentication requests generated when a target user attempts to access the endpoint device 110. In some embodiments, each authentication request may require a single validation. In other embodiments, a single authentication request may require multiple validations (e.g., repeated cycles of the process illustrated in FIG. 2).

As discussed herein, the emulation module 135 determines a direct communication channel for transmitting digital data between a secured computer system and an authentication device 115. The emulation module 135 additionally determines a proximity channel for transmitting digital data to determine the proximity of an authentication device 115 to a computer system.

FIG. 3 s a block diagram of an example system architecture of the emulation module 135, according to one embodiment. The emulation module 135 includes a data link identification module 310, a communication channel module 320, a proximity channel module 330, and a proximity measurement module 340. In some embodiments, the emulation module 135 includes additional modules or components. In some embodiments, the functionality of components emulation module 135 may be performed by other components of the identity verification system 130 or the endpoint device 110.

Before determining a direct communication channel (e.g., the direct communication channel 160), the data link identification module 310 determines the availability of data link circuits at both the computer system (e.g., the endpoint device 110) and the authentication device 115. As discussed herein, data link circuits may be wireless circuits, wired circuits, acoustic circuits, optical circuits, or a combination thereof.

The data link identification module 310 may identify available data link circuits based on system hardware information for both the computer system and the authentication device 115. As described herein, system hardware information includes, but is not limited to, device status information for one or more different data link circuit device drivers installed and/or executing within the computer system, a list of devices discovered within the computer system, information resulting from probing one or more different hardware circuits within the computer system, or a combination thereof.

In one embodiment, after the data link identification module 310 identifies data link circuits available at the computer system and the authentication device 115, the communication channel module 320 attempts to establish a direct communication channel between each data link circuit 111 at the endpoint device 110 with any available data link circuit 117 at the authentication device 115. If the communication channel module 320 determines that a potential communication channel cannot be established by either the computer system, the authentication device 115, or both, the communication channel module 320 determines that the potential communication channel is not available.

For each available data link circuit, the communication channel module 320 determines the state of the data link circuit. The communication channel module 320 measures operation metrics (also referred to herein as “measurable attributes” or “attributes”) for each available data link including, but not limited to, a current a current signal strength, a noise level, an error rate, a dropped packet count, a dropped packet rate, sampling channel (i.e., frequency) occupancy information, a latency time (e.g., a “ping time”) or any other suitable network performance statistic. The communication channel module 320 sequentially evaluates each available data link circuit by comparing the determined state of each data link circuit to a set of threshold requirements. Just as the operation metrics measured for various data link circuit may differ depending on the type of data link circuit (e.g., wired or wireless) or depending on intrinsic properties of each data link circuit, the communications 320 may compare operation metrics for each data link circuit to a different set of threshold requirements depending on the data link circuit.

Before sequentially evaluating the available data link circuits, the communication channel module 320 may prioritize or rank the available data link circuits based on performance attributes of a potential communication channel involving each available data link circuit, for example overall reliability and efficiency. The communication channel module 320 first compares the highest priority or top-ranked data link circuit to the appropriate set of threshold requirements. If the state of the data link circuit satisfies the set of threshold requirements (further described below with reference to FIG. 6), the communication channel module 320 selects the first data link circuit as an endpoint for a direct communication channel between the computer system and the authentication device 115. If the state of the data link circuit does not satisfy the set of threshold requirements, the communication channel module 320 compares the data link circuit with the next priority to the appropriate set of the threshold requirements. The communication channel module 320 repeats this process for each available data link circuit according to the priority of data link circuits until one satisfies the set of threshold requirements. If no data link circuits satisfy the set of threshold requirements, the communication channel module 320 triggers a secondary authentication procedure to authenticate the target user.

Functionality and operation of the communication channel module 320 is further described below with reference to FIG. 6.

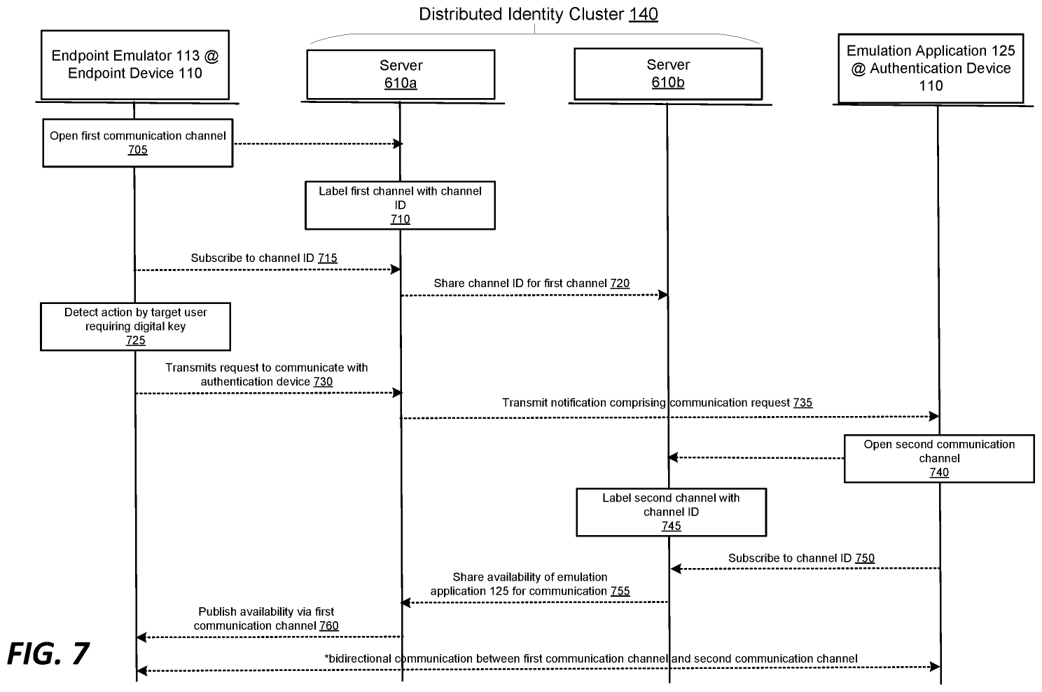

The proximity channel module 330 may implement the same techniques discussed throughout with regards to the communication channel module 320 to select data link circuits at the computer system and the authentication device 115 as endpoints for a proximity channel and determine the proximity channel module 330. Functionality and operation of the proximity module 330 is further described below with reference to FIG. 7.

The proximity channel may include any technically feasible combination of a local wireless signal (e.g., Bluetooth, WiFi, or any other suitable electromagnetic radio frequency signal), an acoustic signal (e.g., audible or ultrasonic), a vibration or motion signal (e.g., haptic transducer, accelerometer, shared location signals (e.g., global positioning signal), or any other measurable physical signals.

In one embodiment, the communication channel module 320 establishes a direct communication channel with the authentication device 115 via a Bluetooth data link. The emulation application 125 may characterize the Bluetooth radio frequency environment with respect to noise and channel occupancy before transmitting the characterization to the emulation module 135. As described herein, “channel occupancy” is a measurement indicative of a time occupancy ratio for a particular communication channel (e.g., whether the communication channel is carrying traffic 1%, 5%, 50% of the time within a measurement interval). In addition, the proximity channel module 330 may separately characterize Bluetooth radio frequency environment with respect to noise and channel occupancy.

The proximity channel module 330 may establish a proximity channel between the data link circuit 111 and the data link circuit 117 if both characterizations are within a threshold similarity. If the two characterizations are within a threshold similarity, the proximity channel module 330 may establish a proximity channel confirming that radio frequency measurements are sufficient proof of the authentication device's 115 proximity to the endpoint device 110. The threshold similarity provides a mechanism to accommodate differences between the computer system and the authentication device 115. As described herein, the threshold similarity indicates that two or more devices (e.g., the computer system and the authentication device 115) each independently measure similar (within a threshold) environmental parameters), which indicate the likely proximity of the two devices. In addition to the examples provided herein, a person having ordinary skill in the art would appreciate that any other technique may be implemented to measure and determine environmental similarity between two or more devices without departing the scope of various embodiments. For example, where the threshold similarity is determined based on channel occupancy, the communication channel module 320 should measure almost identical channel occupancy measurements between the computer system and the authentication device 115 if both measurements are taken in close proximity to each other.

For example, the proximity channel module 330 may determine that both characterizations satisfy the threshold similarity if the most recently measured average channel occupancy for the computer system is within a threshold deviation (e.g., 10%) of the most recently measured average channel occupancy for the authentication device 115.

The communication channel module 320 and the proximity channel module 330 may select the same type or different types of data link circuits for establishing the communication channel and the proximity channel given the variance in availability and reliability of physical data links. For example, a first candidate channel may exist between a Bluetooth data link circuit at the computer system and a Bluetooth data link circuit at the authentication device 115, but Bluetooth signals transmitted between the data link circuits may be noisy and unreliable. A second, more reliable, candidate channel may exist between a wired data link circuit at the computer system (e.g., a wired Ethernet connection) and wireless data link circuit at the authentication device 115 (e.g., a long term evolution (LTE) wireless carrier connection). In this example, the emulation module 135 may select the second candidate channel as the communication channel and the first candidate channel as the proximity channel. Accordingly, the emulation module 135 may establish individual channels between different types of data link circuits (e.g., a channel between a wired data link circuit and a wireless data link circuit). Additionally, the emulation module 135 may select different and independent channels as the communication channel and the proximity channel.

The proximity measurement module 340 measures proximity based on any combination of wireless signals, acoustic signals, vibration or motion signals, shared location signals, or any other measurable physical signals.

In some embodiments, the proximity channel is an acoustic path between acoustic device links of the computer system and the authentication device 115. In such embodiments, the proximity measurement module 340 establishes proximity by modulating the authentication request into an audio signal that is transmitted along the acoustic channel. In one embodiment, the computer system transmits a nonce code encoded within a modulated audio signal across the acoustic channel and the emulation application 125 receives the secret nonce code by demodulating the audio signal. The emulation application 125 transmits the nonce code back to the computer system along the audio channel or a different secondary communication channel (e.g., an interne connection). The emulation application 125 may functionally validate the authentication request by transmitting the correct nonce code back to the emulation module 135. If the emulation application 125 validates the authentication request in this manner, the proximity measurement module 340 may verify the proximity of the authentication device 115 to the endpoint device 110. In another embodiment, the emulation module 135 may generate the nonce code as a random number. The emulation module 135 may randomly generate the nonce code algorithmically, based at least in part on random physical measurements, or both. In yet another embodiment, the emulation module 135 may generate the nonce code using a private key and a sequence counter. In addition to the techniques described herein, the nonce code may be generated using any technically feasible technique.

In some embodiments, the proximity measurement module 340 may measure the proximity of the authentication device 115 using a single-use QR code displayed on the computer system and read by an application installed on the authentication device 115. For example, the authentication device 115 reads a QR code displayed on a computer system using an integrated camera commonly available on mobile devices. The emulation application 110 extracts data from the QR code and transmits the data back to the computer system through a connection between data network (e.g., the Internet, an intranet, etc.). In one example implementation, the emulation application 125 extract data from the QR code including a nonce code of more than sixteen bits (or alternatively more than five hundred bits). In another example implementation, the emulation application 125 opens a universal location record (URL) encoded by the QR code. The URL may cause a cloud service to transmit a proximity validation code back to the proximity measurement module 340 through the network 140. In such embodiments, the proximity measurement module 340 verifies that the authentication device 115 is within a threshold proximity of the computer system when the authenticating device 110 successfully reads the QR code and transmits proof of reading the QR code back to the proximity measurement module 340.

In another example embodiment, the proximity measurement module 340 encodes and displays a nonce code in the form of a QR code. After reading the QR code using an integrated camera, the authentication device 115 generates and displays a code sequence. The computer system displays a prompt for the target user to manually enter the code sequence. When the target user correctly enters the code sequence, the proximity measurement module 340 verifies that the authentication device 115 is within a threshold proximity of the computer system. The code sequence may be generated by cryptographically signing and/or hashing the nonce code encoded in the QR code. The proximity measurement module 340 may implement this technique under circumstances where proximity is required to grant the target user access to the computer system but neither the computer system nor the authentication device 115 are able to connect to a data network.

Additionally, the proximity measurement module 340 may record and transmit physical addresses recorded for Bluetooth devices as evidence of an authentication device's 115 proximity to an endpoint device 110. More generally, the proximity measurement module 340 may continuously monitor radio frequency channels for evidence of continuous proximity to an authentication device.

The proximity measurement module 340 may measure the proximity of the authentication device 115 and the computer system (or another endpoint device or a target user) using any technique compatible with the endpoint device 110, the authentication device 115, or the circumstances surrounding the endpoint device 110. More information regarding proximity-based measurements using an authentication device 115 or any other suitable computing device may be found in U.S. patent application Ser. Nos. 17/542,289 and 17/542,294, both of which are incorporated by reference herein in their entirety.

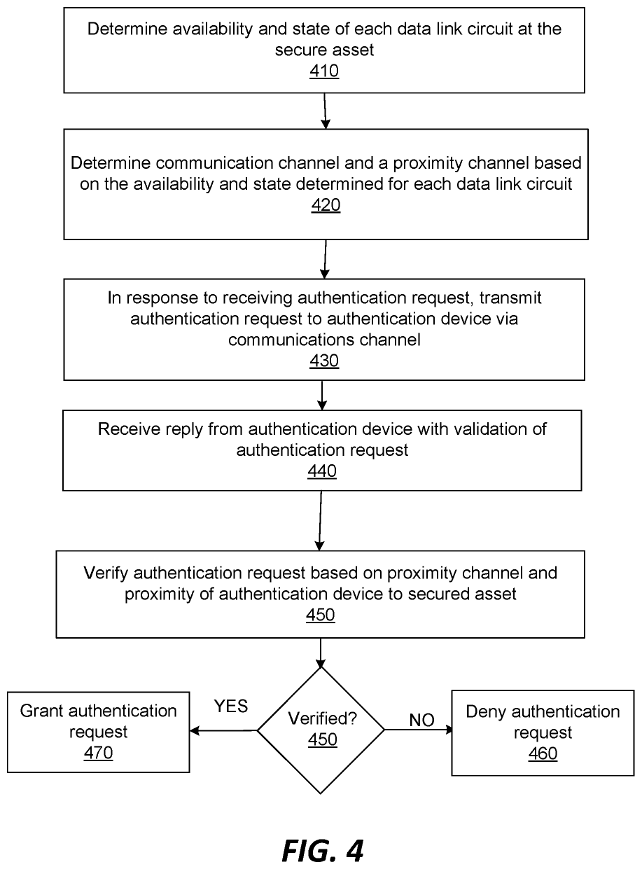

FIG. 4 illustrates an example process for verifying an authentication request from the perspective of the emulation module 135 of the endpoint device 110, according to one embodiment. The emulation module (e.g., the emulation module 135) determines 410 an availability and state of each data link circuit at the computer system (e.g., the endpoint device 110). The emulation module 135 identifies available data link circuits based on system hardware information (as described herein) and characterizes the state of available data link circuits based on operation metrics for each data link circuits (as described herein).

The emulation module 135 determines 420 a communication channel and a proximity channel based on the state of each available data link circuit.

In some embodiments, the emulation module 135 performs steps 410 and 420 prior to receiving an authentication protocol request. In other embodiments, the emulation module 135 performs steps 410 and 420 in response to receiving an authentication request. When the identity verification system 130 receives an authentication request, the emulation module 135 transmits the authentication request to the emulation application 125 of an authentication via the determined communication channel. Before transmission, the emulation module 135 encodes the authentication request into a packet structure or a physical frame structure suitable for transmission over the determined communication channel. The emulation module 135 may implement any technically feasible encoding structure. As discussed herein, the emulation application 125 validates the authentication request and transmits its reply to the emulation module 135. The emulation application 125 may encode its reply and the results of the validation into encapsulated packet or frame. Accordingly, the emulation module 135 receives 440 the reply from the authentication and extracts the reply from the encapsulated packet or frame.

The emulation module 135 verifies 450 the authentication request by measuring the proximity of the authentication device 115 to the endpoint device 110 using the proximity channel. In some embodiments, the emulation module 135 measures the proximity of the authentication device 115 based on direct communications between the computer system and the authentication device 115, for example through a local radio frequency communications data link. The emulation module 135 may measure proximity using signal signatures including, but not limited to, signal levels, noise levels, round trip time, channel occupancy. Techniques for measuring the proximity of the authentication device 115 to the endpoint device 110 are described herein with reference to the proximity measurement module 340 in FIG. 3.

The emulation module 135 generates a response to the initial authentication request based on whether the request was validated by the emulation application 125 and/or whether the request was verified using the proximity channel. The response may comprise an application programming interface (API) (e.g., a function nor method return, a message to a designated handler, a function or method call back, etc.). The response may additionally, or alternatively, include a confirmation indicating that the authentication device 115 is within proximity to the computer system along with the reply received from the emulation application 125. In embodiments where the emulation application 125 validates the authentication request and the emulation module 135 verifies the authentication request using the proximity channel, the identity verification system 130 grants 470 the authentication request. In embodiments where either the emulation application 125 does not validate the authentication request or the emulation module 135 determines that the authentication device 115 is not in proximity to the endpoint device 110, the user verification system denies 460 the authentication request.

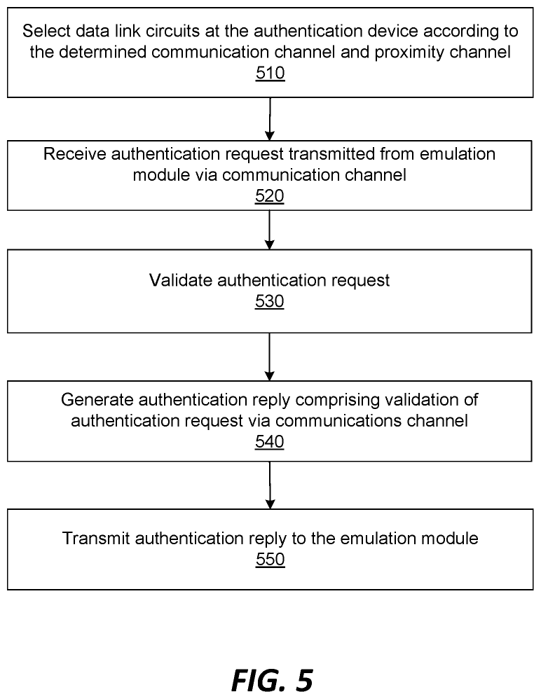

FIG. 5 illustrates an example process for verifying an authentication request from the perspective of the emulation application 125 of the authentication device 115, according to one embodiment. As discussed herein, the emulation module 135 determines a communication channel and a proximity channel based on the available data link circuits and the state of each available data link circuit. The emulation application 125 selects 510 data link circuits at the authentication device 115 corresponding to the determined communication channel and the determined proximity channel.

The emulation application 125 receives 520 the authentication request transmitted from the identity verification system 130 via the determined communication channel. Upon receipt of the authentication request, the emulation application 125 extracts the authentication request from the encoded packet or frame received from the emulation module 135. The emulation application validates 530 the authentication request, for example by verifying that the target user intended to request access to the endpoint device 110. In one embodiment, the authentication request is electronically signed by the computer system (e.g., a cryptographic signature) and the emulation application 125 validates the request by verifying that the computer system originated the authentication protocol request. The emulation application 125 may validate 530 the authentication request using any other suitable technique or source and construction of the authentication request. In addition to the embodiment involving a cryptographic signature described herein, a person having ordinary skill in the art would appreciate that the emulation application 125 may implement any suitable technique to validate the authentication request.

Based on the results of the validation, the emulation application 125 generates 540 an authentication reply. If the emulation application 125 validates the authentication request, the emulation application 125 generates an authentication reply comprising instructions for the emulation module 135 to measure the proximity of the authentication device 115 to the endpoint device 110 before granting access to the endpoint device 110. If the emulation application 125 does not validate the authentication request, the emulation application 125 generates an authentication reply comprising instructions for the emulation module 135 to deny access to the endpoint device 110 regardless of the proximity of the authentication device 115 to the endpoint device 110.

In some embodiments, the emulation application 125 generates the authentication reply by transmitting the authentication request to an authentication circuit (at the authentication device 115) that validates the authentication request, generates authentication replies, or both. In one embodiment, the authentication circuit comprises a device disposed within the authentication device 115 (e.g., a smart card) and in communication with the emulation application 125. In another embodiment, the authentication circuit comprises a secure enclave processor programmed to perform the functions of a smart card device and/or any other technically feasible security device or key. In alternative embodiments, the emulation application 125 directly generates the authentication reply based on the authentication request and locally stored credential data (or a digital key). A person having ordinary skill in the art would readily understand that numerous techniques may applied to generate an authentication reply based on the overall system architecture of the authentication device 115.

The emulation application 125 transmits 550 the authentication reply to the emulation module 135 through the selected communication channel (e.g., the communication channel 120). In one embodiment, emulation application 125 additionally encodes the authentication reply into a packet structure or a physical frame structure appropriate for the selected communication channel prior to transmission.

### Establishing Indirect Communication Channels by a Distributed Server Cluster

As discussed above, in some embodiments, an authentication device 115 lacks the power management capabilities to maintain a persistent direct communication channel with an endpoint device 110. In such embodiments, the authentication device 115 may establish an indirect communication channel with an endpoint device 110 through a distributed system architecture (e.g., the distributed identity server cluster 140). FIG. 6 shows a distributed systems architecture 600 for authenticating a target user requesting access to a secure endpoint device, according to one embodiment. The distributed identity server cluster 140 implements multiple instances, services, and servers distributed across one or more geographic regions. Accordingly, an endpoint device 110 may be connected to a server in a first geography while an authentication device 115 is connected to a different server in a second geography. Because each server of the cluster 140 communicates with other servers of the cluster 140 and is aware of the relationship with the authentication device 115 and the endpoint device 110, the distributed identity server cluster 140 enables the endpoint device and authentication device to bidirectionally communicate across particular communication channels. The distributed identity server cluster implements a multiplexing approach across the identity server cluster 140 by publishing/subscribing messages across communication channels hosted at different servers in different geographic locations. In embodiments where both the endpoint device 110 and the authentication device 115 establish communication channels with the same intermediary server, the server may handle the interaction between the channels locally without multiplexing across the whole intermediary platform. In some embodiments, the distributed identity server cluster 140 publishes or subscribes a queue that temporarily caches messages and instructions in the event of network connection instability. In such cases, if the authentication device 115 loses its network connection and reconnects, the messages transmitted by the endpoint device 110 will still be delivered to the authentication device 115.

The distributed identity server cluster 140 illustrated in FIG. 6, comprises servers 610a and 610b, which are geographically distributed and load balanced. Each server 610 may be located in a different geographic location and able to communicate with the other server 610. The servers 610 of the distributed identity server cluster 140 establish, maintain, and terminate indirect communication channels that allow for communication between the endpoint device 110 and the authentication device 115. Across the distributed identity server cluster 140, each server is available to establish a communication channel with any authentication device 115 and any endpoint device 110 regardless of their location. Additionally, because servers 610 communicate with each other, the distributed identity server cluster 140 can establish an indirect communication channel between an authentication device 115 in one geographic region and an endpoint device 110 in another geographic region. In some embodiments, the emulation application 125 periodically initiates a transient communication channel with the distributed identity server cluster 140. The channel passes through a load balancer (not shown), which routes the channel to any available server 610 or service instance at the distributed identity server cluster 140, for example based on location of the authentication device 115.

For the sake of illustration, the distributed identity server cluster 140 is only illustrated with two servers 610 but may include any number of servers or service instances to cover any number of geographic regions. In some embodiments of the distributed identity server cluster 140, there may be N number of geographic regions and M number of server instances within each geography where both M and N are greater than or equal to 1. Multiple servers and/or server instances allow the distributed identity server cluster 140 to scale with improved fault-tolerance while increasing complexity.

In the illustrated embodiment of FIG. 6, the endpoint emulator 113 of the endpoint device 110 establishes a persistent communication channel 620 with the server 610a. By way of example, the endpoint device 110 may be located in a facility in New York and the server 610a is the server most immediately available to a device located in New York. The emulation application 125 of the authentication device 115 establishes a transient communication channel 630 with server 610b. Given the power management constraints of the authentication device 115, the emulation application 125 may establish the transient communication channel 635 in response to a request from the endpoint device 110 to communicate with the emulation application and deactivate the channel 635 when no request is received. Additionally, a target user located in California may attempt to access the endpoint device 110 using the authentication device 115 to prove their identity. Accordingly, the emulation application establishes the transient communication channel 635 with the server 610b, which is the geographically closest available server to California. Because server 610a and 610b maintain an inter-server communication channel 640, the distributed identity server cluster 140 establishes an indirect communication channel between the endpoint emulator 113 and the emulation application 125 via the persistent communication channel 620, the inter-server channel 640, and the transient communication channel 635. Accordingly, the distributed identity server cluster 140 allows a target user with an endpoint device in one location with the authentication device in a different location by facilitating indirect communication between the endpoint device 110 and the user's authentication device 115.

When the endpoint device 110 requests to communicate with the emulation application 125, the server 610 of the distributed identity server cluster 140 transmits a request to the push notification server 650 for the emulation application 125 to connect to the distributed identity server cluster 140. The push notification server 650 transmits a notification containing the request to the emulation application 125, which triggers the emulation application to reconnect the transient communication channel 635.

FIG. 7 is an interaction diagram for communicating data between an endpoint device and an authentication device via the distributed identity server cluster 140, according to one embodiment. FIG. 7 illustrates interactions between an endpoint emulator 113 at an endpoint device 110, servers 610a and 610b of a distributed identity server cluster 140, and an emulation application 125 at an authentication device 110. The endpoint emulator 113 establishes a connection to server 610a by opening 705 a communication channel with the server 705. In some embodiments, the connection passes through a load balancer of the distributed intermediary platform 140, which routes the connection to any available server at the intermediary platform (e.g., the server 610a).

To open the channel, the endpoint emulator 113 defines 710 a channel ID identifying the endpoint device 110 and the server 610a creates a channel and labels 710 the opened communication channel with the channel ID. The endpoint emulator 113 subscribes 715 to the channel ID for opened communication channel. In one embodiment, the endpoint emulator 113 implements a standards-based protocol, for example STOMP, to transmit messages across the communication channel. In other embodiments, alternate messaging protocols may be implemented. In some embodiments, the server 610a shares 720 the channel ID with other servers, for example, server 610b, of distributed identity server cluster 140 in both the same and different geographic regions as server 610a. In some embodiments, the servers 610a and 610b receive an acknowledgement message(s) upon confirmation that the endpoint emulator 113 has subscribed to the channel ID.

At some point after opening the communication channel (705), the endpoint emulator 113 may detect 725 an action by a target user requiring their digital key, for example, a login attempt, a trigger login, or an unlock initiation. To receive and transmit data regarding the digital key, the endpoint emulator 113 transmits 730 a request to communicate with the emulation application 125 on the authentication device 110 storing the digital key of the target user. The endpoint emulator 113 transmits 730 the request to the server 610a.

In one embodiment, the server 610 looks up the authentication device in a database or lookup table or stored digital keys. In other embodiments, the endpoint emulator 113 specifies the targeted authentication device 110 in its transmitted request (730). In such embodiments, the server 610a transmits 735 a notification to the authentication device 110. In some embodiments, the server 610 transmits 735 a notification through an out-of-band notification server (e.g., push notification server 640). Upon receipt of the notification, the emulation application 125 opens 740 a second communication channel with the distributed identity server cluster 140. As described above regarding the first communication channel (705), the second communication channel passes through a load balancer of the distributed intermediary platform 140, which routes the channel through any available server at the intermediary platform (e.g., the server 610b). In the illustrated embodiment of FIG. 7, the distributed identity server cluster 140 routes the communication channel from the emulation application 125 to the server 610b. In some embodiments, the servers available for establishing the second communication channel query the distributed identity server cluster 140 for the channel ID labeling the first channel. In other embodiments, the notification transmitted by the server 610a (735) comprises the channel ID. Upon receiving the channel ID, the server 610b labels 745 the second channel with the channel ID provided by the endpoint emulator 113 and the emulation application 125 subscribes 750 to the channel ID. In some embodiments, the servers 610a and 610b receive an acknowledgment message(s) upon confirmation that the endpoint emulator 113 has subscribed to the channel ID.

The distributed identity server cluster 140 may additionally recognize the subscription of the emulation application to the channel ID (e.g., the establishment of the second communication channel) and share 755 the availability of the emulation application to communicate with the endpoint device 110 with other servers of the cluster 140 (e.g., the server 610a). In other embodiments, the emulation application 125 publishes its availability to the server 610b and the server 610 publishes the availability across all global servers of the distributed identity cluster 140. Because the endpoint emulator 113 has subscribed to the channel ID (725), the server 610a publishes 760 the availability of the emulation application 125 to the endpoint emulator 113 via the first communication channel.

Once the endpoint emulator 113 and the emulation application 125 have both respectively established the first communication channel and second communication channel and subscribed to the same channel ID, the distributed identity server cluster 140 establishes a bidirectional communication channel between the endpoint device 110 and the authentication device 115 via the established communication channels.

In embodiments where the authentication device cannot sustain a persistent connection, the endpoint emulator 113 may transmit a message to the emulation application indicating that the transaction involving the digital key has been completed (e.g., the digital key of the target user has been authenticated or denied). In such embodiments, the emulation application unsubscribes from the channel ID and disconnects the second communication channel with the server 610b. the distributed identity server cluster 140 notifies all servers in all geographic regions of the disconnection and confirms that the authentication device 110 is no longer available for communication. The distributed identity server cluster 140 may return a receipt to the authentication server 140 confirming that the second communication channel 140 was disconnected.

FIG. 8 illustrates an example process for transmitting data using a distributed identity server cluster from the perspective of a distributed identity server cluster 140, according to one embodiment. The distributed identity server cluster 140 maintains 810 a first communication channel between an endpoint device and a first server of the distributed server cluster. The distributed identity server cluster 140 comprises a plurality of geographically distributed and load-balanced remote servers. At the first server, the distributed identity server cluster 140 receives 820 a request from the endpoint device to communicate with an application stored at an authentication device containing a digital key for accessing the endpoint device. The endpoint device is located within a first geographic region while the authentication device is located in a second geographic region. Accordingly, the distributed identity server cluster 140 allows a target user to access the endpoint device without being the in the same geographic region or physically present near the endpoint device. The distributed identity server transmits 830 a notification to the application stored at the authentication device. The notification comprises instructions for the authentication device to connect with the distributed identity server cluster. The distributed identity server cluster opens 840 a second communication channel between the authentication device and a second server of the distributed server cluster. The distributed identity server cluster 140 additionally maintains an inter-server communication channel to facilitate communication between the first server and the second server. The distributed identity server cluster 140 transmits 850 data between the endpoint device and the authentication device across the first communication channel, the inter-server communication channel and the second communication channel.

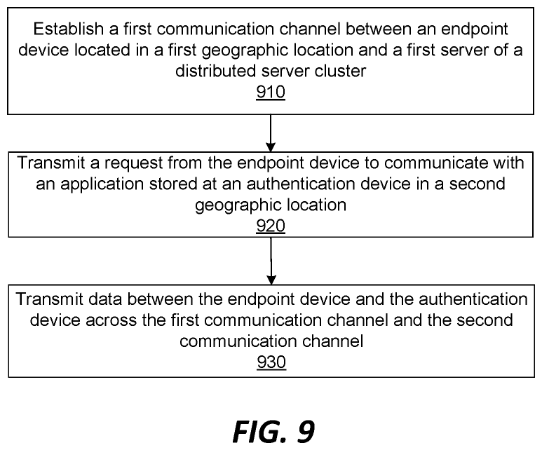

Continuing from FIG. 8, FIG. 9 illustrates an example process for transmitting data using a distributed identity server cluster from the perspective of an endpoint device 110, according to one embodiment. The endpoint device establishes 910 the first communication channel between an endpoint device located in a first geographic location and a first server of a distributed server cluster. When a target user request access to the endpoint device or performs an action requiring their digital key, the endpoint device executes a driver and an application to mimic an insertion or ejection of a physical key at the endpoint device. Accordingly, the endpoint device analyzes the target user's digital key to determine whether to grant access to the target user. The endpoint device transmits 920 a request from the endpoint device to communicate with an application stored at an authentication device in a second geographic location containing the digital key. Once the second communication is established between the authentication device and the distributed identity server cluster, the endpoint device transmits 930 data between the endpoint device and the authentication device across the first communication channel, the second communication channel, and the inter-server communication channel.

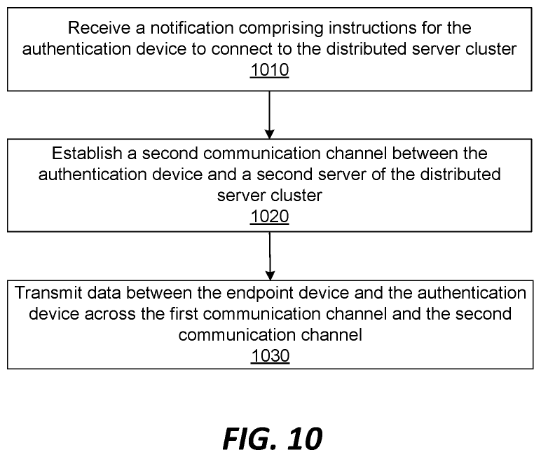

Continuing from FIG. 8, FIG. 10 illustrates an example process for transmitting data using a distributed identity server cluster from the perspective of an authentication device 115, according to one embodiment. The authentication device receives 1010 a notification comprising instructions for the authentication device connect to the distributed server cluster. The authentication device establishes 1020 a second communication channel between the authentication device and the second server of the distributed server cluster. Once the second communication is established between the authentication device and the distributed identity server cluster, the endpoint device transmits 1030 data between the endpoint device and the authentication device across the first communication channel, the second communication channel, and the inter-server communication channel.

The overall advantages and benefits of the system disclosed herein include, for example, enabling an authentication device to appear locally and physically connected to an endpoint device when no such physical connection exists or in environments where a simple intermediary is insufficient, for example, implementations where the endpoint device and authentication device are on different networks such as global cloud computing environments, enterprises with hybrid data centers (cloud and on-premises), with strong security controls, firewalls, network filters blocking directional access. Because the authentication device and the endpoint device need not be physically connected, a target user may securely access the endpoint device from any geographic location by communicating with the endpoint device via the distributed identity server cluster. The multiplexed design of the distributed identity server cluster offers improved scale, fault-tolerance, geographic distribution, and latency optimization over conventional single server intermediaries. The disclosed distributed platform cluster can recognize situations where an authentication device has been disconnected with improved efficiency over conventional systems because when one server recognizes the device has been disconnected it can also communicate the disconnect to all other multiplexed servers.

Additionally, the disclosed distributed identity server cluster enables an endpoint device to be connected and fully functional with a mobile smartphone incapable of persisting a connection due to energy management limitations or other operating limitations. Accordingly, the distributed identity server cluster enables the mobility of the authentication device and eliminates the need for a constant network connection along with the additional power or electrical requirements that would come with that requirement. Although the techniques for establishing a bidirectional communication channel are described herein in the context of authenticating the identity of a target user, a person having ordinary skill in the art would recognize that these techniques may be applied in any other suitable context as well.

### Benefits

The overall benefits of the system disclosed herein enable an authentication device to appear locally and physically connected to an endpoint device when no such physical connection exists or in environments where a simple intermediary is insufficient, for example implementations where the endpoint device and authentication device are on different networks such as global cloud computing environments, enterprises with hybrid data centers (cloud and on premises), with strong security controls, firewalls, network filters blocking directional access. Because the authentication device and the endpoint device need not be physically connected, a target user may securely access the endpoint device from any geographic location by communicating with the endpoint device via the distributed identity server cluster. The multiplexed design of the distributed identity server cluster offers improved scale, fault-tolerance, geographic distribution, and latency optimization over conventional single server intermediaries. The disclosed distributed platform cluster can recognize situations where an authentication device has been disconnected with improved efficiency over conventional systems because when one server recognizes the device has been disconnected it can also communicate the disconnect to all other multiplexed servers.

Additionally, the disclosed distributed identity server cluster enables an endpoint device to be connected and fully functional with a mobile smart phone incapable of persisting a connection due to energy management limitations or other operating limitations. Accordingly, the distributed identity server cluster enables mobility of the authentication device and eliminates the need for a constant network connection along with the additional power or electrical requirements that would come with that requirement.

### Computing Machine Architecture

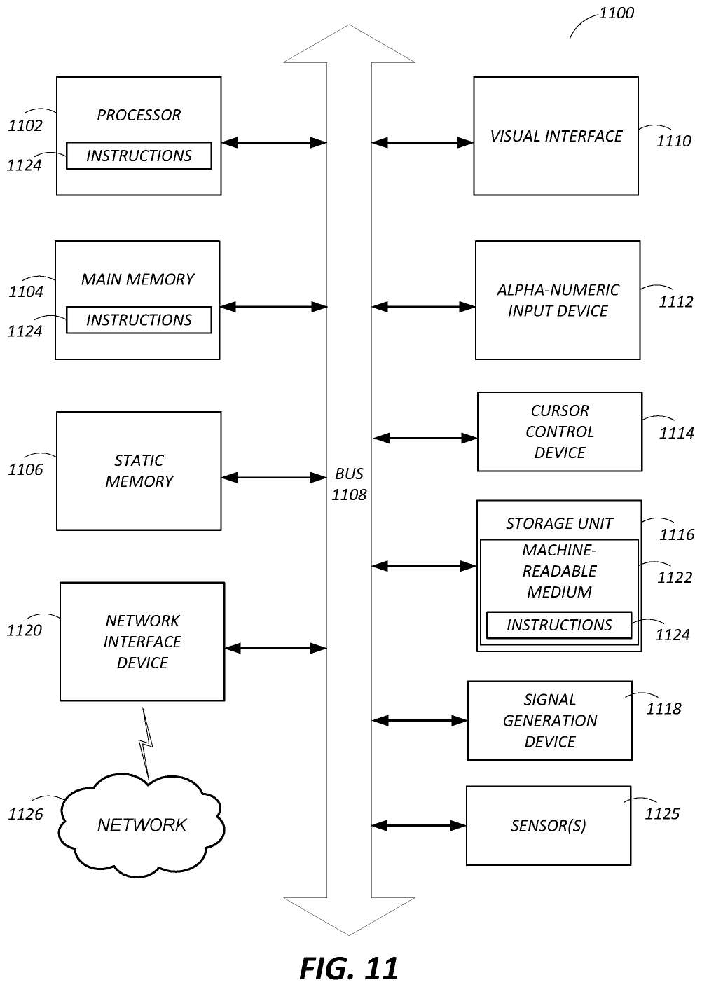

FIG. 11 is a block diagram illustrating components of an example machine able to read instructions from a machine-readable medium and execute them in a processor (or controller). Specifically, FIG. 11 shows a diagrammatic representation of a machine in the example form of a computer system 1100 within which instructions 1124 (e.g., software) for causing the machine to perform any one or more of the processes or (methodologies) discussed herein (e.g., with respect to FIGS. 1-10) may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. It is noted that some or all of the components described may be used in a machine to execute instructions, for example, those corresponding to the processes described with the disclosed configurations.

The machine may be a server computer, a client computer, a personal computer (PC), a tablet PC, a set-top box (STB), a personal digital assistant (PDA), a cellular telephone, a smartphone, a web appliance, an IoT device, a wearable, a network router, switch or bridge, or any machine capable of executing instructions 1124 (sequential or otherwise) that specify actions to be taken by that machine. Further, while only a single machine is illustrated, the term “machine” shall also be taken to include any collection of machines that individually or jointly execute instructions 1124 to perform any one or more of the methodologies discussed herein.

The example computer system 1100 includes a processor 1102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1104, and a static memory 1106, which are configured to communicate with each other via a bus 1108. The computer system 1100 may further include visual display interface 1110. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 1110 may include or may interface with a touch enabled screen. The computer system 1100 may also include alphanumeric input device (e.g., a keyboard or touch screen keyboard), a cursor control device 1114 (e.g., a mouse, a trackball, a joystick, a motion sensor, or other pointing instrument), a storage unit 1116, a signal generation device 1118 (e.g., a speaker), and a network interface device 1120, which also are configured to communicate via the bus 1108. It is noted that the example computer system 1100 need not include all the components but may include a subset.

The storage unit 1116 includes a machine-readable medium 1122 on which is stored instructions 1124 (e.g., software) embodying any one or more of the methodologies or functions described herein. The instructions 1124 (e.g., software) may also reside, completely or at least partially, within the main memory 1104 or within the processor 1102 (e.g., within a processor's cache memory) during execution thereof by the computer system 1100, the main memory 1104 and the processor 1102 also constituting machine-readable media. The instructions 1124 (e.g., software) may be transmitted or received over a network 826 via the network interface device

While machine-readable medium 1122 is shown in an example embodiment to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., instructions 1124) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The disclosed identity verification system 130 enables enterprise systems to track and evaluate a user's access to an operational context in real-time. Compared to conventional systems which determine a user's access at a single point in time, the described identity verification system 130 continuously verifies a user's identity based on characteristic data recorded by a mobile device or a combination of other sources. Because characteristics of a user's movement and activities are unique to individual users, the identity verification system 130 is able to accurately verify a user's identity with varying levels of confidence. Additionally, by leveraging characteristic data recorded for a user, the identity verification system 130 may not be spoofed or hacked by someone attempting to access the operational context under the guise of another user's identity. Moreover, by continuously comparing a confidence identity value for a user to a threshold specific to an operational context, the enterprise system may revoke or maintain a user's access.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for systems and a process for confirming an identity based on characteristic data received from various sources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
maintaining, at a first server of a distributed server cluster, a first communication channel between an endpoint device and the first server, wherein the endpoint device is located in a first geographic region;
receiving, at the first server, a request from the endpoint device to communicate with an application stored at an authentication device located in a second geographic region, the application containing a digital key for accessing the endpoint device;
transmitting a notification to the application stored at the authentication device, the notification comprising instructions for the authentication device to connect with the distributed server cluster;
opening, at a second server of the distributed server cluster, a second communication channel between the authentication device and the second server, wherein the second server and first server communicate through an inter-server communication channel; and
transmitting data between the endpoint device and the authentication device across the first communication channel, the inter-server communication channel, and the second communication channel.

2. The method of claim 1, wherein the distributed server cluster comprises a plurality of geographically distributed and load-balanced remote servers.

3. The method of claim 1, wherein the second communication channel is a transient communication channel disconnected by the authentication device upon completion of a transaction involving the digital key.

4. The method of claim 1, wherein opening the second communication channel comprises:
identifying, by a load balancer stored at the distributed server cluster, the second server as available for establishing the second communication channel with the authentication device.

5. The method of claim 1, wherein the first communication channel is labeled with a channel identifier corresponding to the endpoint device, the method further comprising:
sharing, by the distributed server cluster, the channel identifier amongst other servers of the distributed server cluster; and
receiving a subscription from the authentication device identifying the channel identifier; and
mapping the first communication channel to the second communication channel.

6. The method of claim 1, wherein the authentication device transmits the notification in response to detecting an action by the target user at the endpoint device requiring the digital key.

7. A non-transitory computer-readable medium comprising stored computer-readable instructions that, when executed by a processor of an endpoint device, causes the processor to:
establish a first communication channel between the endpoint device and a first server of a distributed server cluster, wherein the endpoint device is located in a first geographic region;
transmit, from the endpoint device, a request to the first server to communicate with an application stored at an authentication device located in a second geographic region, the application containing a digital key for accessing the endpoint device; and
transmit data between the endpoint device and the authentication device across the first communication channel, an inter-server communication channel between the first server and the second server, and the second communication channel in response to a second server of the distributed server cluster establishing a second communication channel between the authentication device and the second server.

8. The non-transitory computer-readable medium of claim 7, wherein the distributed server cluster comprises a plurality of geographically distributed and load-balanced remote servers.

9. The non-transitory computer-readable medium of claim 7, wherein the second communication channel is a transient communication channel, the instructions further comprising instructions to disconnect the authentication device upon receipt of a notification from the endpoint device confirming the completion of a transaction involving the digital key.

10. The non-transitory computer-readable medium of claim 7, further comprising instructions to open the second communication channel, the instruction to open the second communications channel further comprises instructions that when executed causes the processor to:
identify, by a load balancer stored at the distributed server cluster, the second server as available for establishing the second communication channel with the authentication device.

11. The non-transitory computer-readable medium of claim 7, further comprising instructions to detect an action by the target user at the endpoint device requiring the digital key before transmission of the notification by the endpoint device.

12. The non-transitory computer-readable medium of claim 7, further comprising instructions to cause the endpoint device to:
execute an application to mimic an insertion or ejection of a physical key at the endpoint device based on an action by the target user at the endpoint device requiring the digital key; and
analyze the digital key to determine whether to grant access to the target user.

13. An identity verification system comprising:
an endpoint device located in a first geographic region where a target user performs an action requiring a digital key;
an authentication device located in a second geographic region and storing application containing the digital key for accessing the endpoint device; and
a distributed server cluster comprising a first server and a second server, wherein the distributed server cluster is configured to:
maintain, at the first server of a distributed server cluster, a first communication channel between an endpoint device and the first server, wherein the endpoint device is located in a first geographic region;
receive, at the first server, a request from the endpoint device to communicate with the application stored at an authentication device;
transmit a notification to the application stored at the authentication device, the notification comprising instructions for the authentication device to connect with the distributed server cluster;
open, at the second server of the distributed server cluster, a second communication channel between the authentication device and the second server, wherein the second server and first server communicate through an inter-server communication channel; and
transmit data between the endpoint device and the authentication device across the first communication channel, the inter-server communication channel, and the second communication channel.

14. The system of claim 13, wherein the distributed server cluster comprises a plurality of geographically distributed and load-balanced remote servers.

15. The system of claim 13, wherein the second communication channel is a transient communication channel disconnected by the authentication device upon completion of a transaction involving the digital key.

16. The system of claim 13, wherein the distributed server cluster is further configured to:
identify, by a load balancer stored at the distributed server cluster, the second server as available for establishing the second communication channel with the authentication device.

17. The system of claim 13, wherein the first communication channel is labeled with a channel identifier corresponding to the endpoint device, the distributed server cluster further configured to:
share, by the distributed server cluster, the channel identifier amongst other servers of the distributed server cluster; and
receive a subscription from the authentication device identifying the channel identifier; and
map the first communication channel to the second communication channel.

18. The system of claim 13, wherein the endpoint device is further configured to:
execute an application to mimic an insertion or ejection of a physical key based on an action by the target user at the endpoint device requiring the digital key; and
analyze the digital key to determine whether to grant access to the target user.
